(19) United States
(12) Patent Application Publication
(10) Pub. No.: US 2026/0361452 A1
(43) Pub. Date: Nov. 12, 2026

(54) A NOVEL CHANNEL INDEPENDENT INTERLEAVER

(71) Applicant: ISTANBUL MEDIPOL UNIVERSITESI TEKNOLOJI TRANSFER OFISI ANONIM SIRKETI, Beykoz, Istanbul (TR)

(72) Inventors: Shaima' Samih Saleem ADIBRABBU, Beykoz, Istanbul (TR); Haji Muhammad Furqan Ahmed MADNI, Beykoz, Istanbul (TR); Huseyin ARSLAN, Beykoz, Istanbul (TR)

(21) Appl. No.: 19/142,395

(22) PCT Filed: Nov. 8, 2023
(86) PCT No.: PCT/TR2023/051279

§ 371 Date: Jun. 23, 2025

(30) Foreign Application Priority Data
Dec. 26, 2022 (TR) 2022/020532
Mar. 31, 2023 (TR) 2023/003520

(51) Int. Cl. H04L 1/00; H03M 13/27

(52) U.S. Cl. CPC H04L 1/0041; H03M 13/2778; H04L 1/0071

(57) ABSTRACT

In this invention, novel methods and system of channel-independent interleaver are proposed.

### TECHNICAL FIELD

In this invention, novel methods and system of channel-independent interleaver are proposed.

### PRIOR ART

Although there are many advantages of Rate-splitting multiple access (RSMA), it is vulnerable to several security threats from external and internal Eavesdroppers due to the broadcast nature of wireless networks. The broadcast nature of wireless communication makes it vulnerable to several security threats such as both kinds of eavesdropping (internal and external).

RSMA splits data into common and private, where the private part of data is secure while common is vulnerable to internal and external eavesdroppers. In RSMA, the private streams of data corresponding to different users are transmitted based on space division multiple access (SDMA) using a channel-based precoder which provides them with inherent security from being eavesdropped by internal and external eavesdroppers.

On the other hand, the common stream is constructed by concatenation of the data of all users and is broadcasted to all users, and SIC is applied on each user side to extract their corresponding private streams. Hence, it is vulnerable to internal eavesdroppers as well as external eavesdroppers.

The investigation on RSMA-assisted physical layer security is still in its early stage. Recently, in some prior art documents studied RSMA-based two-user multiple input single output (MISO) secure communications by treating the common stream as both artificial noise (AN) to confuse the eavesdroppers and useful data for legitimate users to improve the sum rate. A robust and secure resource allocation strategy was then proposed for user fairness optimization.

Similarly, a cooperative rate-splitting (CRS) technique, originally proposed in some prior art, was further investigated in a MISO broadcast channel (BC) with an external single antenna eavesdropper in some prior art document, where the proposed CRS strategy considered the legitimate user to opportunistically relay and forward its re-encoded common message to serve as AN to confuse the eavesdropper and as a useful message for the other legitimate user. The precoders and time-slot allocation strategy were then jointly optimized to maximize the secure sum rate. Additionally, in some prior art documents extended RSMA-based physical layer security to simultaneous wireless information and power transfer (SWIPT) systems and proposed a robust beamforming design to maximize the worst-case EE performance. With the aid of the AN, RSMA-based secure beamforming and power allocation design were investigated in some prior art documents to maximize the secure sum rate.

The RSMA-assisted physical layer security is based on the optimization of secrecy rate and secrecy capacity based on channel-based adaptation and artificial noise, but there is no specific mechanism to provide security for both common and private parts of the user's data in RSMA. Some of the works in the literature focused on providing security for the private part of the data of RSMA users while ignoring the security of the common part of data.

Motivated by these works, novel methods that can provide security for both common and private parts by using inherent features of RSMA structures are proposed in this invention. The investigation on RSMA-assisted physical layer security is still in its early stage. Recently, some document in prior art studied RSMA-based two-user multiple input single output (MISO) secure communications by treating the common stream as both artificial noise (AN) to confuse the eavesdroppers and useful data for legitimate users to improve the sum rate. A robust and secure resource allocation strategy was then proposed for user fairness optimization.

Similarly, a cooperative rate-splitting (CRS) technique, originally proposed in prior art, was further investigated in a MISO broadcast channel (BC) with an external single antenna eavesdropper in some prior art documents, where the proposed CRS strategy considered the legitimate user to opportunistically relay and forward its re-encoded common message to serve as AN to confuse the eavesdropper and as a useful message for the other legitimate user. The precoders and time-slot allocation strategy were then jointly optimized to maximize the secure sum rate. Additionally, extended RSMA-based physical layer security to simultaneous wireless information and power transfer (SWIPT) systems and proposed a robust beamforming design to maximize the worst-case EE performance. With the aid of the AN, RSMA-based secure beamforming and power allocation design were investigated in to maximize the secure sum rate.

The RSMA-assisted physical layer security is based on the optimization of secrecy rate and secrecy capacity based on channel-based adaptation and artificial noise but there is no specific mechanism to provide security for both common and private parts of user's data in RSMA. Some of the works in the literature focused on providing security for the private part of the data of RSMA users while ignoring the security of the common part of data.

The RSMA-assisted physical layer security is based on the optimization of secrecy rate and secrecy capacity based on channel-based adaptation and artificial noise but there is no specific mechanism to provide security for both common and private parts of user's data in RSMA. Some of the works in the literature focused on providing security for the private part of the data of RSMA users while ignoring the security of the common part of data.

### BRIEF DESCRIPTION AND OBJECTS OF THE INVENTION

The present invention is related to the field and methodologies of “” in order to eliminate the above-mentioned disadvantages and provide new advantages to the relevant technical field.

This invention focuses on solving the security issue of the common part of RSMA data from being intercepted by internal and external eavesdroppers. Although the private part is secured due to the inherent structure of RSMA, the invention proposed method provides another level of security to the private part of data for RMSA users.

Invention proposed novel methods that can provide security for both common and private parts by using inherent features of RSMA structures.

In RSMA-based multiple access, the data is divided into two parts. The parts that are broadcasted to all users are known as the common part while the part that will be received by only a specific user is known as the private part.

Rate-splitting multiple access (RSMA) has emerged as a powerful non-orthogonal transmission framework and interference management strategy for future wireless networks. Furthermore, the performance advantage of RSMA has also been demonstrated in terms of robustness against imperfect channel state information at the transmitter (CSIT) and user mobility, spectral efficiency (SE), energy efficiency (EE), user fairness, reliability, quality of service (QOS) enhancements, etc.

On the other hand, the broadcast nature of wireless communication makes it vulnerable to several security threats, such as both kinds of eavesdropping (internal and external). In the invention, the method proposed a novel channel-independent interleaved based on the inherent structure of RSMA, that can be applied to sub-blocks, bits, and symbols for providing secure communication without the need for pre-shared information for interleaver or keys.

This disclosed invention is used in any wireless network that uses rate splitting as a multi-access approach to serving multi-users in the network. The technical interest can be used in many areas such as (some examples but not strict in these only):
1—LINK ADAPTION AND MODULATION
2—CHANNEL ESTIMATION AND DETECTION
3—Enhanced throughput and reliability mechanisms
4—MAC layer management and specifications
5—Non-orthogonal unicast and multicast transmission (NOUM)
6—Multi-cell MIMO including coordinated multi-point (COMP), cloud-radio access network (C-RAN), and fog-radio access network (F-RAN)
7—Cooperative user relaying networks
8—Efficient precoding design aspects
9—Joint Radar and communication (JRC) applications.
10—Massive Mimo Networks
11—Ultra-reliable and low-latency communications (URLLC)
12—millimeter-wave (mm Wave) communication
13—Unmanned aerial vehicles-aided communications (UAV)
14—Physical layer security (PLS)
15—Massive machine-type communication (mMTC)
16—Cognitive radio networks (CRN)
17—Device to device Communication (D2D).

RSMA has been shown to generalize and subsume as special cases four existing multiple access (MA) schemes, namely, orthogonal multiple access (OMA), physical layer multicasting, space division multiple access (SDMA) based on linear precoding (currently used in the fifth-generation wireless network-5G), and non-orthogonal multiple access (NOMA) based on linearly precoded superposition coding with successive interference cancellation (SIC). Through information and communication theoretic analysis, RSMA is optimal (from a degrees-of-Freedom region perspective) in several transmission scenarios.

RSMA enables user messages to be split into certain common and private parts, after which the private parts are independently encoded into private streams while the common parts are jointly encoded into common streams superposed on top of the private streams. The superposed streams are then precoded and transmitted from the multi-antenna transmitter. On the receiver side, successive interference cancellation (SIC) is applied at each user to enable sequential decoding of the common streams and the intended private stream. Receivers then reconstruct the original messages by extracting the intended common part from the decoded common message and combining it with the decoded private message.

Although there are a lot of advantages of RSMA, it is vulnerable to several security threats from external and internal Eavesdroppers due to the broadcast nature of wireless networks. The broadcast nature of wireless communication makes it vulnerable to several security threats such as both kinds of eavesdropping (internal and external). RSMA split data into common and private, where the private part of data is secure while common is vulnerable to internal and external eavesdroppers.

In RSMA, the private streams of data corresponding to different users are transmitted based on SDMA using a channel-based precoder which provides them with inherent security from being eavesdropped by internal and external eavesdroppers. On the other hand, the common stream is constructed by concatenation of the data of all users and is broadcasted to all users and SIC is applied on each user side to extract their corresponding private streams. Hence, it is vulnerable to internal eavesdroppers as well as external eavesdroppers.

The purpose of the invention is to solve the security issue of the common part of RSMA data from being intercepted by internal and external eavesdroppers. Although the private part is secured due to the inherent structure of RSMA, method in invention provides another level of security to the private part of data for RMSA users.

The proposed methods can provide secure and efficient communication for RSMA-based systems without depending on conventional cryptography-based security solutions. More specifically, the proposed method can solve the following problems related to conventional security:
Future networks consist of large-scale heterogeneous and decentralized wireless networks in which key management, distribution, and maintenance processes are quite challenging.
Future networks need to support new wireless technologies like 5G-Tactile Internet, Internet of Things (IOT), Ultra-Reliable Low-Latency Communication (ULLRC), and remote surgery. However, the devices used in these applications are naturally power-limited, processing-restricted, and delay-sensitive which makes cryptography-based techniques unfeasible for such types of technologies.
Future networks are expected to support diverse services and scenarios that have different security requirements. The encryption-based method cannot provide scenario-specific security.
The proposed method can provide security without conventional cryptography-based methods thus avoiding key sharing, distribution, and management issues for future networks.
The proposed method can be implemented to provide flexible and scenario-specific security because the proposed methods can be used individually or jointly.
Compared to the conventional security method the proposed method can provide security without degrading the bit error rate (BER) performance of a legitimate node or causing an increase in the peak-to-average power ratio (PAPR) at the transmitter. As well as no throughput loss is introduced.
The proposed method does not cause a loss in spectral efficiency, and it does not sacrifice power to generate noise as in some other techniques of security in the literature.
It can provide security against external and internal eavesdroppers.
As the interleaver is data dependent and varied for every frame. Hence, it is difficult for an attacker to guess the interleaver sequence.
The proposed method is focused on the security point of view. However, the proposed joint design of common and private can be extended to design new channel encoding, modulation, power allocation, and diversity techniques.
By applying the proposed approach, the SIC works normally without any changes in the conventional RSMA structure which means that the applied method is not changing the inherent structure of the RSMA.
The methods are proposed for rich scattering environments but can also be extended to sparse channel cases or poor scattering environments. Moreover, it can also be extended to multi-carrier communication cases.
Several technical problems can be solved if the proposed approach has been applied to the RSMA network which is the best candidate for 5G and beyond, and 6g networks. These problems are:
   Eavesdropping problem {internal and external}
   Burst error.
   Errors from interference and noise.

### FIGURES

The figures used to better explain the analysis method developed with this invention are as follows.

FIG. 1: RSMA transmitter design for the proposed invention (Method 1).

FIG. 2: RSMA receiver design for the proposed invention (Method 1).

FIG. 3: RSMA receiver design for the proposed bit level interleaver (Method 2).

FIG. 4: RSMA receiver design for the proposed symbol level interleaver (Method 3).

### REFERENCE LIST

The components of system and methods which are shown in figures that are individually numbered and given below.
BS: Transmitter
SIC: Successive interference cancellation
Int i: Interleaved subblocks
G: Interleaver sequence generator
g_i: Output sequence
B: the total number of subblocks
vL: Subbset of total subblocks
nInt_I: Non-interleaved subblocks
D′_i: The resultant stream
D′_1: The resultant stream of data 1
D′_2: The resultant stream of data 2
PP 1: Private parts of D′_1
PP 2: Private parts of D′_2
C: The resultant common stream
xp1: Encoder to streams of symbols,
Z: Deinterleaver
xp2: Mapped to streams of symbols
xc: The common stream of symbols
U1: User 1
U2: User 2
D: Data
C1: Common part of user 1
C2: Common part of user 2
D1: Data 1
D2: Data 2
N_i: Antenna
Eve: eavedropper
y_1: Transmitted signal of received by user 1
y_2: Transmitted signal of received by user 2
y_e: Transmitted signal of received by user eavedropper

### DETAILED DESCRIPTION OF THE INVENTION

The novelty of the invention has been described with specific examples in the channel independent interleaver that shall not limit the scope of the invention and which have been intended to only clarify the subject matter of the invention. The present invention has been described in detail below.

The main focus of the invention is to provide security to the common stream of RSMA networks from external and internal eavesdroppers since the private stream of transmitted data is inherently secure in RSMA.

The proposed method can provide security without conventional cryptography-based methods, thus avoiding hardware overhead and issues related to sharing, distribution, and management of keys since it deals with only the features at the physical layer level from the channel.

Particularly, the estimation and mitigation of channels is an inherent part of a reliable communication process. Moreover, a channel-based precoder is an inherent part of RSMA.

The proposed method of the invention is using the inherent structure of RSMA to ensure secure communication.

Rate-splitting multiple access (RSMA) has emerged as a powerful non-orthogonal transmission framework and interference management strategy for future wireless networks. On the other hand, the broadcast nature of wireless communication renders it prone to various threats such as eavesdropping. The invention is aimed at providing a mechanism to secure communication against these threats using inherent features of RSMA without sharing secret keys.

Rate-splitting multiple access (RSMA) has emerged as a powerful non-orthogonal transmission framework and interference management strategy for future wireless networks.

RSMA enables user messages to be split into certain common and private parts, after which the private parts are independently encoded into private streams while the common parts are jointly encoded into common streams superposed on top of the private streams. The superposed streams are then precoded and transmitted from the multi-antenna transmitter. On the receiver side, successive interference cancellation (SIC) is applied at each user to enable sequential decoding of the common streams and the intended private stream. Receivers then reconstruct the original messages by extracting the intended common part from the decoded common message and combining it with the decoded private message.

Although there are a lot of advantages of RSMA, it is vulnerable to several security threats from external and internal Eavesdroppers due to the broadcast nature of wireless networks. The broadcast nature of wireless communication makes it vulnerable to several security threats such as both kinds of eavesdropping (internal and external). RSMA split data into common and private, where the private part of data is secure while common is vulnerable to internal and external eavesdroppers.

In RSMA, the private streams of data corresponding to different users are transmitted based on SDMA using a channel-based precoder which provides them with inherent security from being eavesdropped by internal and external eavesdroppers.

On the other hand, the common stream is constructed by concatenation of the data of all users and is broadcasted to all users and SIC is applied on each user side to extract their corresponding private streams. Hence, it is vulnerable to internal eavesdroppers as well as external eavesdroppers.

Linear encoder based MIMO (Multiple Input Multiple Output) is a wireless communication technique that uses multiple antennas at both the transmitter and the receiver to improve communication performance. The linear encoder is a signal processing technique that linearly combines the signals from multiple antennas to improve signal quality, reliability, and increase data rates. In MIMO communication, linear encoding helps to mitigate the effects of multipath fading and interference, resulting in a more robust communication system. MIMO with linear encoding is widely used in modern wireless communication systems such as 4G LTE and 5G networks.

There are several scheduling approaches in wireless communication networks that are used to allocate resources to multiple users efficiently:
1) Round Robin: A simple scheduling approach where resources are allocated to each user one after the other in a cyclic manner.
2) Proportional Fair Scheduling: This approach allocates resources based on the users' channel conditions, transmission rate, and past history of resource allocation.
3) Maximum Throughput Scheduling: This approach allocates resources to the user with the maximum potential throughput.
4) Long-Term Fair Scheduling: This approach takes into account not only the current channel conditions, but also the long-term behavior of the users to allocate resources fairly over an extended period.
5) Quality of Service (QOS) Scheduling: This approach takes into account the specific QoS requirements of different applications and allocates resources accordingly.
6) Hybrid Scheduling: This approach combines multiple scheduling methods to meet specific network requirements and constraints.

These are some of the commonly used scheduling approaches in wireless communication networks. The choice of scheduling approach depends on the specific requirements and constraints of the network.

### System Model and Proposed Method

In order to explain the details of the proposed method consider the following system model.

In general, a novel interleaver that based on the inherent structure of RSMA is proposed. The proposed interleaver can be applied at bits, symbols, or sub-blocks levels. The actual problem that solved by the proposed algorithms is to provide security of common part of data in RSMA. The basic philosophy of the proposed design is to design a novel interlever to provide security of common part based on inherent secure private part in RSMA.

### System model

Consider a two-user RSMA system, where an RSMA transmitter, BS (Base station/RSMA transmitter), with a N_i antenna wants to communicate with legitimate users, U1 (user1) and U2 (user2), in the presence of an Eavesdropper, Eve. The Eavesdropper, Eve, is trying to passively intercept the information being exchanged between the RSMA transmitter and the users. The channel between any pair of nodes links can be modeled as slowly varying Rayleigh fading. Under channel reciprocity assumption, the channel, (h_i, BS), between i_th user (U_i) and transmitter (BS) can be used to estimate the channel, (h_BS, i), between transmitter (BS) and any user (U_i). Also, the channel, (h_BS, i), from the transmitter (BS) to i_th user is different and independent from the channel, (h_BS, e), from the transmitter (BS) to the eavesdropper due to the fact that realistic channels are specific to positions. Additionally, it is also assumed that Alice has no information about the channel of Eve because of its passive operation. Note that the above system model can be scalable to more than two user cases, the two-user assumption is just for explanation.

### Proposed Methods

In proposed method, invention proposed a novel channel-independent interleaved based on the inherent structure of RSMA, that can be applied to sub-blocks, bits, and symbols for providing secure communication without the need for pre-shared information for interleaver or keys.

Invention proposed three methods based on joint designs of private and common streams of RSMA for securing users' data from internal and external eavesdroppers as follows:
1. Sub-block-based channel-independent interleaver,
2. Bit level channel-independent interleaver,
3. Symbol level channel-independent interleaver.

The steps of the linear precoder stage;

The precoder is designed for each user based on channel and then multiplied with the private stream of the respective user and then superimposed together.

More specifically, linear precoders in multiple-input multiple-output (MIMO) systems can be used for the configuration of subchannels in Rate Splitting Multiple Access (RSMA). And this can be done using the following steps:
1) Establish the MIMO channel: The MIMO channel between the transmitter and receiver should be established, and the channel state information should be obtained.
2) Select linear precoding method: Based on the channel state information, an appropriate linear precoding method should be selected. There are several linear precoding methods available, such as zero-forcing (ZF), regularized zero-forcing (RZF), and minimum mean-square error (MMSE) precoding.
3) Compute the precoder matrix: The precoder matrix should be computed based on the selected linear precoding method and the channel state information.
4) Apply the precoder to the data: The precoder matrix should be applied to the data to be transmitted on each subchannel. This adjusts the power levels and improves the quality of the signal.

By using linear precoding in RSMA, the network can achieve improved performance, such as higher spectral efficiency, better power efficiency, and reduced interference among users. Linear precoding can also help to improve the quality of the signal transmitted on each subchannel, which can further improve the overall performance of the network.

Invention proposed novel methods that can provide security for both common and private parts by using inherent features of RSMA structures.

There are three methods in invention. These are;

Method 1: Sub-block-based Channel-independent Interleaver for Rsma

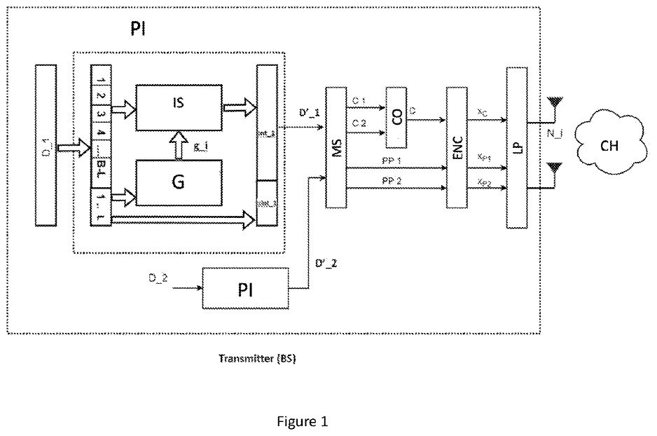

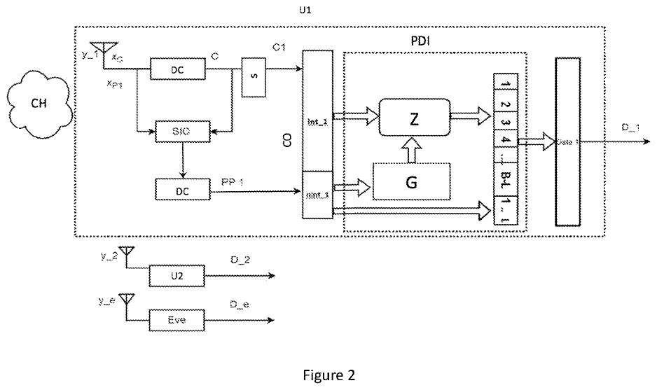

Based on the system model explained above, in order to secure data, D_i, of i_th user's data, where i∈(1,2), the following steps are followed:
Before going to the RSMA transmission structure, dividing data into subblocks ((Based on the proposed RSMA transmitter shown in FIG. 1) In this step that cannot provide a bit-level interleaver because using a subset of data for interleaving and the combination provided by that subset of data cannot be suitable for a bit-level interlaver. Hence, dividing into subblocks and bits are used for subblock-based interleaver.)),
Afterward, selecting L out B subblocks, and using the bits in those L blocks as input to the interleaver sequence generator (G) (The interleaver gives an output sequence, g_i, based on input bits which are then used to interleave the remaining L-B sub-blocks, as shown in FIG. 1 (B is the total number of subblocks and L is the number of subblocks in subbset of total B subblocks),),
Obtaining an output sequence by the interleaver, based on input bits which are then used to interleave the remaining L-B sub-blocks,
Afterward, combining the subblocks which are to make a new stream, D′ i, that contains bits corresponding to interleaved subblocks (Int_i) and the bits corresponding to non-interleaved subblocks(nInt_I), by combiner (CO),
Using the resultant stream as an input to the RSMA transmission structure for i_th user and in the bit splitter (message splitter) of the RSMA structure, dividing the bits into common and private parts that are used as an input for interleaver generator (The resultant stream (D′_i) is then used as an input to the RSMA transmission structure for i_th user. In the bit splitter of the RSMA structure, the bits are divided into common and private parts while making sure that bits (in the non-interleaved sub-blocks (nInt_I)) that are used as an input for interleaver generator will go to the private part. Note that these bits are needed at the receiver to de-interleave the data into the correct order. Hence, if the security of these bits is ensured then the security of common bits can be ensured. So, these bits are sent by the private stream which is based on SDMA and that can provide channel-based security for these bits),
Repeating the above process for user 2 to get the resultant stream of user 2 (D_2′),
Afterward, encoding and mapping the private parts (PP 1, PP 2) of D′_1 and D′_2, respectively, for two users independently to streams of symbols, xp1 and xp2, respectively, while their common parts (C1 and C2) are concatenated in to, C.
Then, encoding and mapping of the resultant common stream (C) is to the stream of symbols, xc.
Pre-coding and superimposing of the common and private streams of symbols, (xc and (xp1 and xp2)) linearly and then transmitting from the multi-antenna transmitter to the receiver via a multi-path Rayleigh fading channel,
Receiving the transmitted signal by i_th user and the eavesdropper as y_i and y_e, respectively,
Detecting and decoding the common stream first by the i_th user and then applying successive interference cancellation (SIC) to detect and decode the intended i_th private stream (Based on the proposed RSMA receiver structure in FIG. 2),
Reconstructing the messages by extracting the intended common part from the decoded common message and combining it with the decoded private message,
Afterward, the data streams contain bits corresponding to the total number of subblocks (B)-Subbset of total subblocks (L) interleaved sub-blocks (Int_i) and bits corresponding to L non-interleaved sub-blocks (nInt_I),
Using the bits corresponding to L non-interleaved sub-blocks (nInt_I) as an input for deinterleaver, (Z), where deinterleaver (Z) gives the sequence zi,
Finally, using the sequences (zi) for deinterleaving the subblocks to get the original message.

Note that Eve received the signal, y_e, but she cannot be able to get the original message even if it can decode the common part of data for any user. This is due to the fact that, in order to get the original message, Eve needs to know the input bits for subblock level de-interleaver. However, these bits are sent using private streams which are inherently secure due to the use of a channel based precoder. Hence, Eve cannot get the original message. Moreover, due to the same reason, users can not intercept each other's data and only the corresponding legitimate node will get the correct original message.

### Method 2: Bit Level Channel-Independent Interleaver

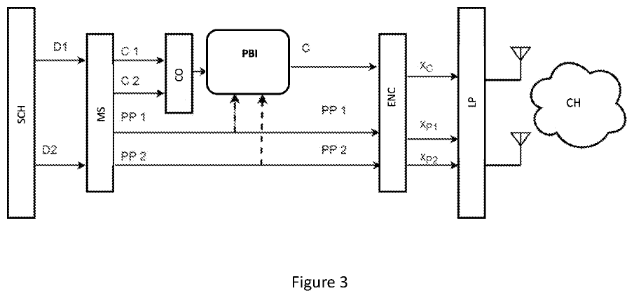

FIG. 3 shows an alternate version of the proposed method. In this method, the conventional RSMA transmitter is modified only at the common bits block. Particularly, the proposed method is based on using bits of private streams to design interleaver at the bit level or sub-block level for common streams.
At the receiver, the decoded private bits are used to design interleaver at the bit level or sub-block level for common streams. Since these bits can be decoded at legitimate nodes only. It can provide security against external and internal eavesdroppers.

### Method 3: Symbol Level Channel-Independent Interleaver

In this method, a common-private joint design at the symbol level for providing security is proposed. This proposed method does not require any change in the RSMA transmitter structure at the bit level. However, modification is applied at the symbol level for providing security.

The details of methods:

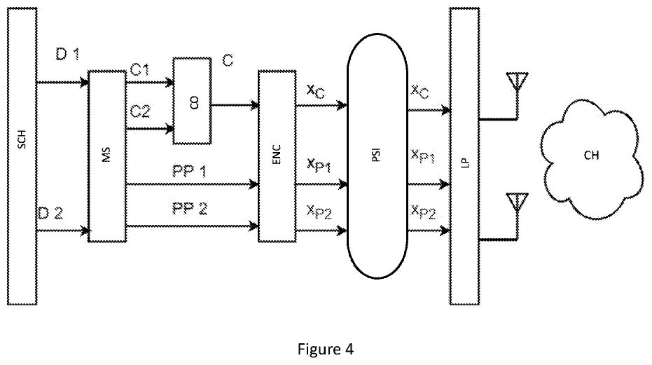

Based on the proposed method 3 presented in FIG. 4.
Following the steps of conventional RSMA, the private parts (PP 1, PP 2) of D1 and D2, respectively, for two users are independently mapped to streams of symbols, xp1 and xp2, respectively, while their common parts (C1 and C2) are concatenated in to, C, jointly encoded and mapped to the stream of symbols, xC,
To provide security for both users U1, and U2, interleaving the real and imaginary parts of U1 and U2 in the common stream of symbols (xC) with the real and imaginary parts of their corresponding private streams (xp1, xp2) of symbols,
Precoding and superimposing the resultant common and private streams of symbols are linearly and then transmitting from the multi-antenna transmitter to the receiver via a multi-path Rayleigh fading channel,
Receiving of the transmitted signal is i_th user and eavesdropper respectively,
Based on the proposed RSMA receiver structure, detecting a common stream of symbols first by the i_th user and then applying successive interference cancellation (SIC) to detect the intended i_th private stream of symbols,
Reconstructing the messages by extracting the intended common part from the detected common stream of symbols and combining it with the detected private stream of symbols,
Afterward, at each receiver, interleaving the real and imaginary parts in the common stream of symbols with the real and imaginary parts of their corresponding private streams of symbols,
Finally, decoding of the stream of symbols to get the original message.

Note that Eve received the signal, but she cannot be able to get any information from the common stream of symbols. This is due to the fact that the real and imaginary parts in the common stream of symbols are interleaved with the real and imaginary parts of their corresponding private streams of symbols, where Eve cannot access the private stream of symbols and hence cannot access the original symbols. Due to the same reason, an internal Eve can also not get any useful information from the common part of the stream of symbols.

Conventional RSMA cannot provide security for the common part while the private stream is secure in it. The proposed technique can provide security to the common part as well as further improve the security of the private part.

From a structural perspective, all the components in the conventional and proposed are the same but there are new blocks such as interleaver design and de-interleaver block. Due to the involvement of these blocks, the design of another dependent component also changes such as splitter.

System comprising;
Splitter: Based on the proposed secure RSMA, one of the essential steps of the proposed algorithms is the splitter. This splitter is used in the first algorithm before going to the RSMA transmission structure, where the data, D_i, is divided into B subblocks. Also, another splitter will be used to split the data into common and private streams based on the RSMA structure.
Interleaver sequence generator: The interleaver is the second essential element in the proposed invention. In this invention based on the interleaver, three algorithms are proposed: sub-block level, bit-level, and symbol level.
Independently encoder: The encoder is used to assign the coding scheme selection, where the coding scheme is used for each user independently. This is a fundamental element in the RSMA networks, where the error effect that is caused by the channel can be handled effectively.
Linear precoder: The linear precoder is designed for each user based on channel and then multiplied with the private stream of the respective user and then superimposed together. More specifically, linear precoders in multiple-input multiple-output (MIMO) systems can be used for the configuration of subchannels in Rate Splitting Multiple Access (RSMA).
Detection: decoding and using SIC. Based on the proposed RSMA receiver structure, each user will detect and decode the common stream first and then apply successive interference cancellation (SIC) to detect and decode the intended private stream. This is a fundamental element to apply RSMA.
Deinterleaver: Based on the used interleaver at the transmitter, the receiver has to apply the corresponding deinterleaver either based on the bit or symbol level. In the deinterleaver, the sequences are regenerated based on the private parts then apply these sequences on the common parts to get the correct order of the common data.
Combiner: After that, each user in the RSMA network has to combine the two parts of common and private to get his signal.

1. A system of interlever to provide security of common part based on inherent secure private part in RSM, the system comprising:
a splitter which is used for a first algorithm before going to a rate splitting multiple access (RSMA) transmission structure, where data is divided into subblocks and to split the data into common and private streams based on the RSMA structure;
an interleaver sequence generator which is based on the interleaver, sub-block level, bit-level and symbol level;
a linear precoder which is used to assign a coding scheme selection, where the coding scheme is used for each user independently;
a detector and decoder part which is providing detect and decode the common stream first to user and applying successive interference cancellation to detect and decode the intended private stream;
a deinterleaver which is based on the used interleaver at the transmitter and regenerating of sequence based on the private parts and which is applying these sequences on the common parts to get the correct order of the common data; and,
a combiner which is combining of the common and private parts to get his signal by each user in the RSMA network.

2. A method of channel independent interleaver that can provide security for both common and private parts by using inherent features of RSMA structures, that comprises the following steps:
dividing data into subblocks used for subblock-based interleaver;
selecting a number of subblocks in subset of total subblocks (L) and using the bits in those L blocks as input to the interleaver sequence generator (G);
afterward, combining the subblocks by combiner to make a new stream as a resultant stream that contains bits corresponding to interleaved subblocks (Int_i) and the bits corresponding to non-interleaved subblocks (nInt_I);
using of resultant stream as an input to the RSMA transmission structure for i_th user and also repeating this process for second user to get the resultant stream;
encoding and mapped the private parts user 1 and user 2, respectively, for two users independently by encoder and mapped to streams of symbols, while their common parts are concatenated in to the resultant common stream;
encoding and mapping of the resultant common stream to the stream of symbols;
linearly pre-coded, superimposed of the common and private streams of symbols, and transmitting from the multi-antenna transmitter to the receiver via a multi-path Rayleigh fading channel;
receiving the transmitted signal by user and eavesdropper;
detecting and decoding the common stream by the i_th user;
applying successive interference cancellation (SIC) to detect and decode the intended i_th private stream;
reconstructing the messages by extracting the intended common part from the decoded common message and combining it with the decoded private message by the i_th receiver;
obtaining bits corresponding to the total number of subblocks (B)-Subbset of total subblocks (L) interleaved sub-blocks (Int_i) and bits corresponding to L non-interleaved sub-blocks (nInt_I) of data streams;
using of the bits corresponding to L non-interleaved sub-blocks (nInt_I) as an input for deinterleaver where deinterleaver (Z) gives the sequence; and,
using the sequences to deinterleave the subblocks to get the original message.

3. The method of claim 2, further comprising:
at the receiver, using of the decoded private bits to design interleaver at the bit level or sub-block level for common streams to security against external and internal eavesdroppers.

4. The method of claim 2, further comprising:
mapping to streams of symbols independently, the private parts of data respectively, for two users while their common parts are concatenated into the resultant common stream (C), jointly encoded and mapped to the stream of symbols;
to provide security for both user 1 and user 2, interleaving the real and imaginary parts of in the common stream of symbols with the real and imaginary parts of their corresponding private streams of symbols;
precoding and superimposing the resultant common and private streams of symbols are linearly and then transmitting from the multi-antenna transmitter to the receiver via a multi-path Rayleigh fading channel;
receiving of the transmitted signal is i_th user and eavesdropper respectively;
based on the proposed RSMA receiver structure, detecting a common stream of symbols first by the i_th user and then applying successive interference cancellation to detect the intended i_th private stream of symbols;
reconstructing the messages by extracting the intended common part from the detected common stream of symbols and combining it with the detected private stream of symbols;
at each receiver, interleaving the real and imaginary parts in the common stream of symbols with the real and imaginary parts of their corresponding private streams of symbols; and
decoding of the stream of symbols to get the original message.
